(19) United States
(12) Patent Application Publication
(10) Pub. No.: US 2011/0148985 A1
(43) Pub. Date: Jun. 23, 2011

(54) PARALLEL MOTION SYSTEM FOR INDUSTRIAL PRINTING

(75) Inventors: David ALBERTALLI, Santa Clara, CA (US); Nile LIGHT, Livermore, CA (US); Robert D. TAFF, Oakland, CA (US); Jason MAXEY, San Pablo, CA (US)

(73) Assignee: ULVAC, INC., Kanagawa (JP)

(21) Appl. No.: 12/975,871

(22) Filed: Dec. 22, 2010

Related U.S. Application Data
(60) Provisional application No. 61/289,690, filed on Dec. 23, 2009.

(51) Int. Cl. B41J 23/00

(52) U.S. Cl. 347/37

(57) ABSTRACT

A microdeposition system includes a printhead carriage that moves along a first axis; a stage that holds a substrate; a rail located above the printhead carriage and extending along a third axis parallel to the first axis; and an accessory carriage that travels along the rail to remain above the printhead carriage. The printhead carriage includes a plurality of nozzles that deposit droplets of fluid material onto the substrate.

### CROSS-REFERENCE TO RELATED APPLICATIONS

This application claims the benefit of U.S. Provisional Application No. 61/289,690, filed on Dec. 23, 2009. The disclosure of the above application is incorporated herein by reference in its entirety.

### FIELD

The present disclosure relates to industrial printing and more particularly to systems and methods of providing parallel motion between a printing carriage and a second carriage.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Manufacturers have developed various techniques for fabricating microstructures that have small feature sizes. The microstructures may form one of more layers of an electronic circuit. Examples of these structures include light-emitting diode (LED) display devices, polymer LED (PLED) display devices, organic LED (OLED) devices, liquid crystal display (LCD) devices, and printed circuit boards. Many of these manufacturing techniques are relatively expensive to implement and require high production quantities to amortize the cost of the fabrication equipment.

One technique for forming microstructures on a substrate is screen printing. During screen printing, a fine mesh screen is positioned on the substrate. Fluid material is deposited through the screen and onto the substrate in a pattern defined by the screen. Screen printing therefore causes contact between the screen and the substrate. Contact also occurs between the screen and the fluid material, which contaminates both the substrate and the fluid material.

While screen printing is suitable for forming some microstructures, many manufacturing processes do not allow contamination of the substrate by the screen. Therefore, screen printing is not a viable option for the manufacture of certain microstructures. For example, polymer light-emitting diode (PLED) display devices may require a contamination-free manufacturing process.

Certain polymeric substances can be used to manufacture diodes that generate visible light of different wavelengths. Using these polymers, display devices having pixels with sub-components of red, green, and blue can be created. PLED fluid materials enable full-spectrum color displays and require very little power to emit a substantial amount of light. PLED displays can be used in various applications, including televisions, computer monitors, PDAs, other handheld computing devices, cellular phones, etc. PLED technology may also be used for manufacturing light-emitting panels that provide ambient lighting for office, storage, and living spaces. One obstacle to the widespread use of PLED display devices is the difficulty and expense of manufacturing PLED display devices.

Photolithography is another manufacturing technique that is used to manufacture microstructures on substrates. Photolithography may also be incompatible with PLED display devices. Manufacturing processes using photolithography generally involve the deposition of a photoresist material onto a substrate. The photoresist material is cured by exposure to light. A patterned mask is therefore used to selectively apply light to the photoresist material. Photoresist that is exposed to the light is cured and unexposed portions are not cured. The uncured portions can be removed from the substrate while the cured portions remain.

An underlying surface of the substrate is exposed through the removed photoresist layer. Another material is then deposited onto the substrate through the opened pattern on the photoresist layer, followed by the removal of the cured portion of the photoresist layer.

Photolithography has been used successfully to manufacture many microstructures, such as traces on circuit boards. However, photolithography contaminates the substrate and the material formed on the substrate. Photolithography may not be compatible with the manufacture of PLED displays because the photoresist contaminates the PLED polymers. In addition, photolithography involves multiple steps for applying and processing the photoresist material. The cost of the photolithography process can be prohibitive when relatively small quantities are to be fabricated. Further, expensive PLED material may be lost when it is deposited on cured photoresist that is later removed.

Spin coating has also been used to form microstructures. Spin coating involves rotating a substrate while depositing fluid material at the center of the substrate. The rotational motion of the substrate causes the fluid material to spread evenly across the surface of the substrate. Spin coating is also an expensive process because a majority of the fluid material does not remain on the substrate. In addition, the size of the substrate is limited by the spin coating process to less than approximately 12″, which makes spin coating unsuitable for larger devices such as PLED televisions.

### SUMMARY

A microdeposition system includes a printhead carriage that moves along a first axis; a stage that holds a substrate beneath the printhead carriage and that moves the substrate along a second axis perpendicular to the first axis; a rail located above the printhead carriage and extending along a third axis parallel to the first axis; a mounting bracket that moves along the rail; an accessory carriage that is rotatably attached to the mounting bracket; and a position controller that controls the accessory carriage and the printhead carriage to move in unison.

In other features, the printhead carriage includes a plurality of nozzles that deposit droplets of fluid material onto the substrate. The accessory carriage includes firing electronics that control firing of the plurality of nozzles. The printhead carriage includes a plinth and a turntable. The turntable holds printheads including the plurality of nozzles and rotates within the plinth. The accessory carriage rotates in unison with the turntable. The printhead carriage includes motors that move the printhead carriage along the first axis. The position controller electrically communicates with the motors via cables routed along the mounting bracket.

In further features, the position controller controls a position of the printhead carriage along the first axis to a first accuracy and controls a position of the accessory carriage along the third axis to a second accuracy that is less accurate than the first accuracy. Vacuum, solvent, pressurized air, and the fluid material are transmitted between the accessory carriage and the turntable using flexible fluid connections. Firing signals from the firing electronics are transmitted between the accessory carriage and the turntable using flexible electrical connections.

In other features, the plinth includes sliding couplings that slide parallel to the first axis. The accessory carriage is interlocked with the sliding couplings by rigid interlink rods. The interlink rods have first ends pivotably coupled to the accessory carriage. The interlink rods have opposite ends pivotably coupled to the sliding couplings. The plinth includes sensors that generate error signals when the sliding couplings move past first predetermined positions on the plinth. The position controller stops movement of the accessory carriage and the printhead carriage when one of the error signals is generated. The plinth includes hard stops that prevent the sliding couplings from moving past second predetermined positions on the plinth.

A microdeposition system includes a printhead carriage that moves along a first axis; a stage that holds a substrate; a rail located above the printhead carriage and extending along a third axis parallel to the first axis; and an accessory carriage that travels along the rail to remain above the printhead carriage. The printhead carriage includes a plurality of nozzles that deposit droplets of fluid material onto the substrate.

In other features, the accessory carriage includes firing electronics that control firing of the plurality of nozzles. Firing signals from the firing electronics are transmitted between the accessory carriage and the printhead carriage using flexible electrical connections. The microdeposition system further includes a position controller that controls the accessory carriage and the printhead carriage to move in unison. The position controller controls a position of the printhead carriage along the first axis to a first accuracy and controls a position of the accessory carriage along the third axis to a second accuracy. The second accuracy is less accurate than the first accuracy. In various implementations, the first accuracy is at least 1000 times as accurate as the second accuracy.

In other features, the microdeposition system further includes an interlock bracket that slides along the rail. The accessory carriage is mounted to the interlock bracket. The printhead carriage includes a motor that moves the printhead carriage along the first axis. The position controller electrically communicates with the motor via cables routed along the interlock bracket. The microdeposition system further includes an air line routed along the interlock bracket that actuates a device to lock the printhead carriage in place.

In further features, the microdeposition system further includes an interlock bracket that slides along the rail. The accessory carriage is mounted to the interlock bracket. The printhead carriage includes a plinth and a turntable. The turntable holds printheads including the plurality of nozzles. The plinth includes motors that move the turntable along an axis perpendicular to the substrate, and wherein control signals for the motors are transmitted from the accessory carriage via cables routed along the interlock bracket.

In other features, the turntable rotates within the plinth in a plane parallel to the substrate. The accessory carriage is rotatably attached to the interlock bracket. The accessory carriage rotates in unison with the turntable. Control signals for rotation of the turntable are transmitted via cables routed along the interlock bracket. Vacuum, solvent, pressurized air, and the fluid material are transmitted between the accessory carriage and the printhead carriage using flexible fluid connections.

In further features, the printhead carriage includes a sliding coupling that slides along a direction parallel to the first axis, and further includes a rigid interlink rod connected between the accessory carriage and the sliding coupling. The printhead carriage includes at least two sliding couplings, and further includes at least two rigid interlink rods that connect the accessory carriage to respective ones of the sliding couplings. The interlink rod has a first end coupled to the accessory carriage using a first spherical pivot. The interlink rod has an opposite end coupled to the sliding coupling using a second spherical pivot.

The printhead carriage includes a sensor that generates an error signal when the sliding coupling moves past first predetermined positions on the printhead carriage. Movement of the accessory carriage and the printhead carriage is stopped when the error signal is generated. The printhead carriage includes hard stops that prevent the sliding coupling from moving past second predetermined positions on the printhead carriage. The microdeposition system further includes at least one beam that is parallel to the first axis and is mechanically isolated from the rail. The printhead carriage moves along the at least one beam.

Further areas of applicability of the present disclosure will become apparent from the detailed description provided hereinafter. It should be understood that the detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is an isometric view of an example microdeposition system;

FIG. 2 is a simplified side view of an example microdeposition system with an accessory carriage and superstructure;

FIG. 3A is a photographic view of an example accessory carriage and superstructure and an example printhead carriage supported on an aluminum frame;

FIG. 3B is an isometric view of a microdeposition system including an accessory carriage and accessory superstructure;

FIG. 3C is a front view of the microdeposition system of FIG. 3B;

FIG. 3D is another isometric view from a different perspective of the microdeposition system of FIG. 3B;

FIG. 3E is a top view of a microdeposition system including an accessory carriage and superstructure;

FIG. 3F is an isometric view of the microdeposition system of FIG. 3E;

FIG. 3G is a side view of the microdeposition system of FIG. 3E;

FIG. 3H is a front view of the microdeposition system of FIG. 3E;

FIG. 4 is a simplified front view of an example microdeposition system;

FIG. 5 is a shaded isometric view of an example accessory carriage and accessory superstructure;

FIG. 6A is another isometric view of the accessory carriage and accessory superstructure;

FIG. 6B is a top view of the accessory carriage and accessory superstructure;

FIG. 7A is an isometric view of the accessory carriage;

FIG. 7B is an isometric view of an example electronics pack from the accessory carriage;

FIGS. 7C-7D are isometric views of a printed circuit board for the electronics assembly for FIG. 7B;

FIG. 8A is an isometric view of a linkage assembly between the accessory carriage and the printhead carriage;

FIG. 8B is an exploded view of the coupling apparatus of FIG. 8A;

FIG. 8C is another exploded view of the coupling apparatus of FIG. 8A;

FIG. 9A is an isometric view of a connection structure, where the coupling apparatus of FIG. 8A connects to the printhead carriage;

FIG. 9B is another isometric view of the connection interface;

FIG. 10A is an isometric view showing electrical and fluid couplings between the printhead carriage and the accessory carriage;

FIG. 10B is an isometric view of an example pack of printhead modules;

FIG. 10C is a more detailed view of fluid and electrical couplings between the printhead carriage and the accessory carriage;

FIG. 10D is a front view of the fluid and electrical couplings between the printhead carriage and the accessory carriage;

FIG. 10E is a side view of the fluid and electrical couplings;

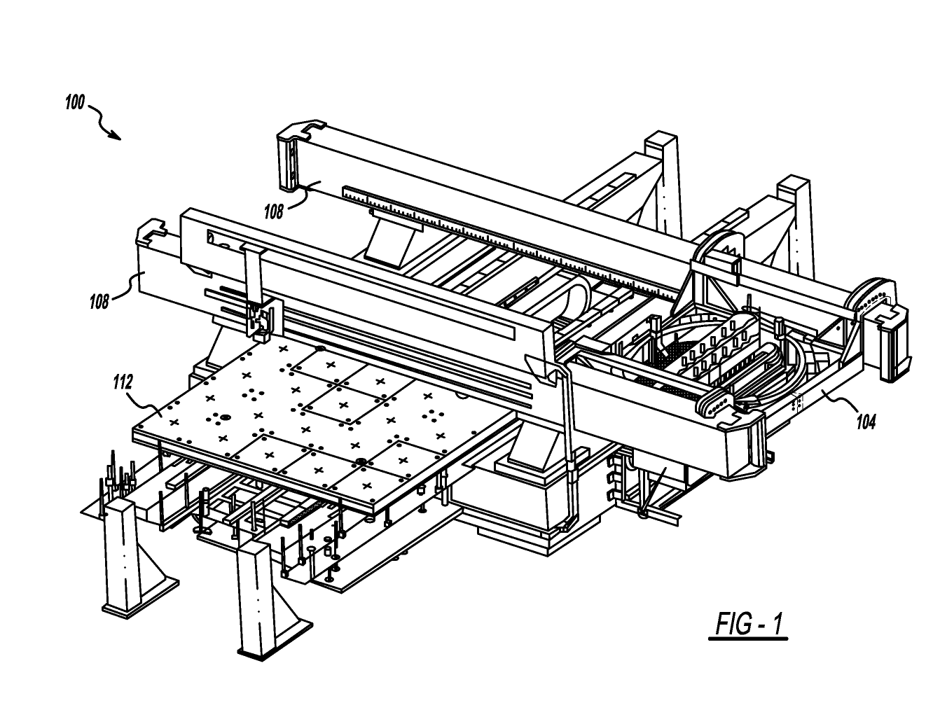

FIG. 1OF is an isometric view of the accessory carriage including a service crane;

FIG. 11A is an isometric view of an example pack including six printhead modules;

FIG. 11 B is a photographic view of plumbing within the pack;

FIG. 11C-11D are isometric views of the pack including six printhead modules;

FIG. 12A is an isometric view of an example printhead carriage including a rotating turntable apparatus;

FIG. 12B is an isometric view of an example implementation of the rotating turntable apparatus; and

FIG. 12C is an isometric view of the printhead carriage with the turntable apparatus not shown.

### DETAILED DESCRIPTION

The following description is merely illustrative in nature and is in no way intended to limit the disclosure, its application, or uses. For purposes of clarity, the same reference numbers will be used in the drawings to identify similar elements. As used herein, the phrase at least one of A, B, and C should be construed to mean a logical (A or B or C), using a non-exclusive logical or. It should be understood that steps within a method may be executed in different order without altering the principles of the present disclosure.

The terms “fluid manufacturing material” and “fluid material,” as defined herein, are broadly construed to include any material that can assume a low viscosity form and that is suitable for being deposited, for example, from a microdeposition head onto a substrate for forming a microstructure. Fluid manufacturing materials may include, but are not limited to, light-emitting polymers (LEPs), which can be used to form polymer light-emitting diode display devices (PLEDs and PolyLEDs). Fluid manufacturing materials may also include plastics, metals, waxes, solders, solder pastes, biomedical products, acids, photoresists, solvents, adhesives, and epoxies. The term “fluid manufacturing material” is interchangeably referred to herein as “fluid material.”

The term “deposition,” as defined herein, generally refers to the process of depositing individual droplets of fluid materials on substrates. The terms “let,” “discharge,” “pattern,” and “deposit” are used interchangeably herein with specific reference to the deposition of the fluid material from a microdeposition head, for example. The terms “droplet” and “drop” are also used interchangeably.

The term “substrate,” as defined herein, is broadly construed to include any material having a surface that is suitable for receiving a fluid material during a manufacturing process such as microdeposition. Substrates include, but are not limited to, glass plate, pipettes, silicon wafers, ceramic tiles, FR-4 and other printed circuit board materials, rigid and flexible plastic, and metal sheets and rolls. In certain embodiments, a deposited fluid material itself may form a substrate, as the fluid material itself also includes surfaces suitable for receiving a fluid material during manufacturing, such as, for example, when forming three-dimensional microstructures.

The term “microstructures,” as defined herein, generally refers to structures formed with a high degree of precision, and that are sized to fit on a substrate. Because the sizes of different substrates may vary, the term “microstructures” should not be construed to be limited to any particular size and can be used interchangeably with the term “structure.” Microstructures may include a single droplet of a fluid material, any combination of droplets, or any structure formed by depositing the droplet(s) on a substrate, such as a two-dimensional layer, a three-dimensional architecture, and any other desired structure.

The microdeposition systems referenced herein perform processes by depositing fluid materials onto substrates according to user-defined computer-executable instructions. The term “computer-executable instructions,” which is also referred to herein as “program modules” or “modules,” generally includes routines, programs, objects, components, data structures, or the like that implement particular abstract data types or perform particular tasks such as, but not limited to, executing computer numerical controls for implementing microdeposition processes.

Program modules may be stored on any non-transitory, tangible computer-readable media, including, but not limited to RAM, ROM, EEPROM, CD-ROM or other optical disk storage, magnetic disk storage or other magnetic storage devices, or any other medium capable of storing instructions or data structures and capable of being accessed by a general purpose or special purpose computer.

Referring now to FIG. 1, a microdeposition system 100 includes a printhead carriage 104 that slides along beams 108. For example only, the beams 108 may be constructed from granite. The direction of travel of the printhead carriage 104 is referred to as the x axis. The printhead carriage 104 includes one or more rows of nozzles that deposit a fluid manufacturing material on a substrate 112. For example only, the substrate 112 may be a sheet of glass and may be a component of a PLED video monitor or television.

The substrate 112 may be secured by a chuck, which may hold the substrate 112 using a vacuum. The system translates the substrate 112 back and forth along the y axis, which is perpendicular to the x axis. The printhead carriage 104 may align the rows of nozzles to be parallel to the x axis and move to a certain position on the x axis. As the substrate 112 moves along the y axis, the rows of nozzles selectively deposit fluid manufacturing material onto the substrate 112. The rows of nozzles may not be able to cover the entire substrate 112 in one pass. The printhead carriage 104 may therefore translate to another position along the x axis. The substrate 112 will then move along the y axis to print another pass.

Alternatively, the printhead carriage 104 may align the rows of nozzles to be perpendicular to the x axis and print while moving the printhead carriage 104 along the x axis. The substrate 112 would then translate to a new position along the y axis after each pass is completed. The nozzles in the printhead carriage 104 may be periodically maintained to ensure uniform dispensing of droplets. In various implementations, nozzle maintenance may be performed when the substrate 112 is being loaded into the microdeposition system 100 and/or when the substrate 112 is being unloaded from the microdeposition system 100.

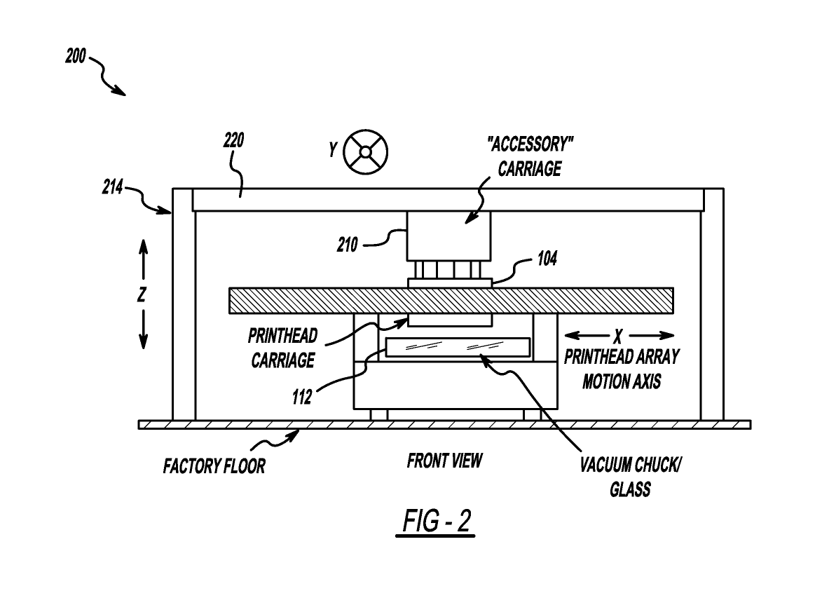

Referring now to FIG. 2, a simplified side view of a microdeposition system 200 is shown. The printhead carriage 104 moves side to side along the x axis. The substrate moves in the y direction, into and out of the plane of FIG. 2. The printhead carriage 104 may move up and down along the z axis, such as to allow for different thicknesses of substrate.

The printhead carriage 104 may include multiple arrays of printhead modules. Each array of modules may be connected as a pack to a common pack mounting block. In various implementations, each printhead module may include multiple nozzles. For example only, four packs of six printhead modules each, with each printhead module having 128 nozzles, may be present.

The printhead modules may include fluid supply controls and built-in actuators to precisely align the nozzles with each other and with the substrate 112. With a large number of nozzles and the associated mounting structures, the weight of the printhead carriage 104 may be significant. In addition, packs of printhead modules may translate with respect to each other within the printhead carriage 104. For example only, each pack may translate in the y axis by approximately 400 mm with respect to the other head packs.

The weight of the printhead carriage 104 may be even greater when the printhead carriage 104 includes a rotating turntable to change the pitch of the nozzles with respect to the substrate 112. For example, the turntable within the printhead carriage 104 may rotate the packs together between 0 degrees and 90 degrees, where 0 degrees corresponds to the rows of nozzles being parallel to the x axis and 90 degrees corresponds to the rows of nozzles being perpendicular to the x axis. In various implementations, printing may be performed at rotations between 0 and 70 degrees, while 90 degrees is used for printhead maintenance.

In addition, actuators within the printhead carriage 104 that move the packs in the z axis may add to the weight. For example only, the mass of the printhead carriage 104 may be more than 300 pounds. In addition, a fluid supply system and nozzle driver electronics may be required for operation of the printhead modules. For example only, these systems may weigh 500 pounds.

The time it takes the printhead carriage 104 to move and settle to a stable state may affect throughput of the microdeposition system 200. In order to move the printhead carriage 104 quickly enough for a given throughput, acceleration and deceleration rates of as much as 9.8 meters per second squared or more may be produced. However, when stopping such a large mass so quickly, oscillations may occur. For example, a lateral deflection of the printhead carriage 104 by more than 0.2 microns may prevent printing from starting. Once the deflection decreases below 0.2 microns, printing may resume.

According to the present disclosure, nozzle driver electronics and fluid supply systems can be moved to an accessory carriage 210 that travels along an accessory superstructure 214. The accessory superstructure 214 may be separately attached to the floor so that acceleration forces and vibration experienced by the accessory carriage 210 are not transferred into the printhead carriage 104. The accessory carriage 210 and the printhead carriage 104 may be connected by flexible electrical and fluid links. In various implementations, the electrical links may include electrical cables and/or fiber optic cables. For example only, the fiber optic cables may carry control signals and network data.

The accessory carriage 210 may therefore be independently actuated—although its movement should mirror the movement of the printhead carriage 104. In addition, the accessory carriage 210 may rotate as the turntable of the printhead carriage 104 rotates. Because the electrical and fluid links are flexible, the accessory carriage 210 may be positioned less precisely than the printhead carriage 104. For example only, while the printhead carriage 104 is actuated to achieve a positional accuracy of 0.5 microns, the accessory carriage 210 may be positioned within 25 millimeters. As used herein, an accuracy of 0.5 microns means that an achieved position will be no further than 0.5 microns away from the desired position in either direction—in other words, plus or minus 0.5 microns.

In various implementations, the accessory carriage 210 may be controlled to within a more precise range, such as 1 or 2 millimeters, of the printhead carriage 104, while 25 millimeters remains a failsafe limit. If the offset between the accessory carriage 210 and the printhead carriage 104 increases above 25 mm, movement of both the printhead carriage 104 and the accessory carriage 210 may be immediately stopped to prevent damage from occurring. When the printhead carriage 104 is controlled to a first accuracy of 1 micron or less, such as 0.5 microns, and the accessory carriage 210 is controlled to a second accuracy of 1 millimeter or more, such as 2 millimeters, the first accuracy is at least 1000 times more accurate (1 millimeter/1 micron). In various other implementations, the first accuracy may only be 100-1000 times as accurate as the second accuracy, or 10-100 times as accurate.

In addition, mechanical links may prevent the printhead carriage 104 and the accessory carriage 210 from diverging by more than a threshold, such as 25 millimeters. The mechanical links may supplement the stopping power of the electrical system, and may be a failsafe for the electronic motor control. In various implementations, the electronic interlock may be actuated once the hard mechanical interlock engages. The interlocks may be designed to allow up to a predetermined mismatch, such as 25 millimeters, to be present at any point along the length of travel of the printhead carriage 104.

After full acceleration, the upper beam 220 of the accessory superstructure 214 may move as much as 3 millimeters. Because the accessory superstructure 214 is bolted to the floor, the accessory superstructure is mechanically isolated from the beams 108, and this oscillation is not transferred to the printhead carriage 104. An upper beam 220 of the accessory superstructure 214, along which the accessory carriage 210 rides, may be an aluminum extrusion. In various implementations, the upper beam 220 may be 21 feet long, meaning that even a 0.5 degree twist over the length of the upper beam 220 could result in a 20 millimeter error.

This error may result in an x offset, a y offset, a theta x offset, a theta z offset, and/or a z offset. The mechanical links may therefore couple the printhead carriage 104 and the accessory carriage 210 with five degrees of freedom. For example, small amounts of offset along the y axis and offset along the z axis may be allowed up to a threshold such as 8 millimeters.

The printhead carriage 104 may be positioned within 0.5 microns, which may depend on the stiffness of the x-y stage, the mass of the printhead carriage 104, choice of servo electronics and magnets used to drive linear motors, resolution of a linear encoder for position determination, and the servo control method used.

The x axis position of the accessory carriage 210 may be controlled to within three microns. The approximately six times greater tolerance for the accessory carriage 210 may be the result of a different selection of linear motors for the accessory carriage 210 and the printhead carriage 104. For example, an iron core winding may be used for the accessory carriage 210, which may be more efficient in generating force but may suffer from velocity ripple and cogging effects. Meanwhile, the printhead carriage 104 may be translated using a linear motor having an ironless winding, allowing for greater accuracy.

By relocating heavy components from the printhead carriage 104 to the accessory carriage 210, the settle time of the printhead carriage 104 is reduced. In various implementations, manufacturing flat panel displays may involve 7 to 15 passes. Printing substrates for high definition televisions may involve 20 to 30 passes.

If the printhead carriage 104 took two seconds to settle after each step, 30 passes would occupy more than 60 seconds just in movement time of the printhead carriage 104. In order to complete both printing and movement of the printhead carriage 104 within 60 seconds, a stop and settle time of the printhead carriage 104 for a 400 millimeter step may be reduced below 300 milliseconds. This may represent a six times improvement over previous architectures. Overall manufacturing throughput in a factory may be improved, for example, by 10 to 15 percent.

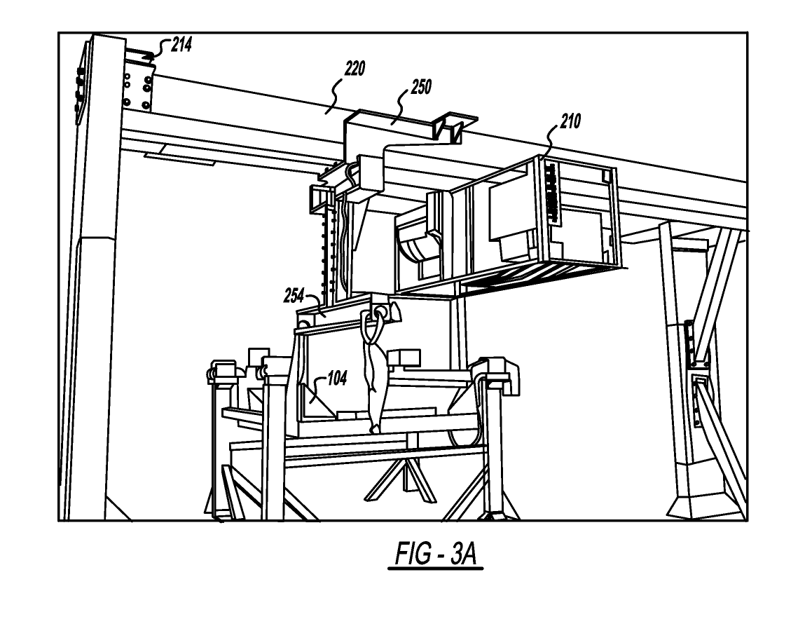

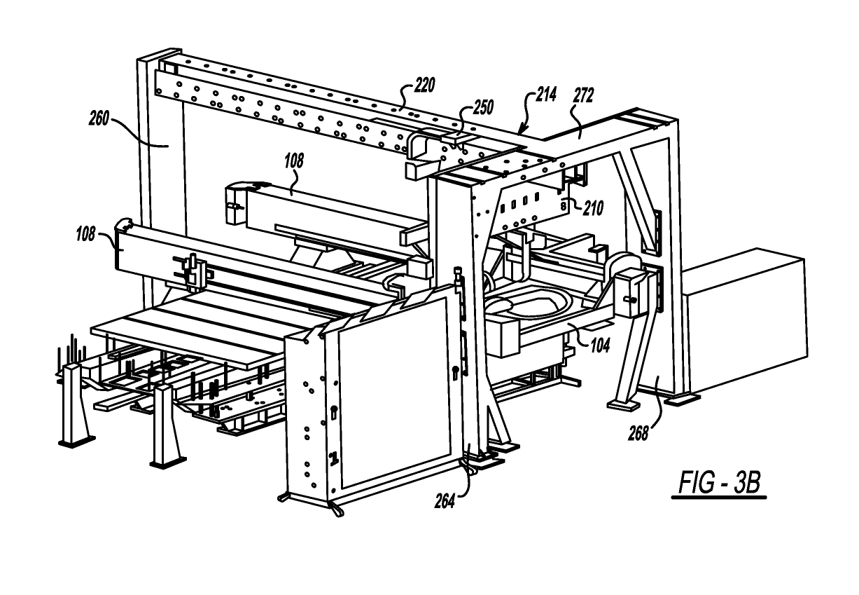

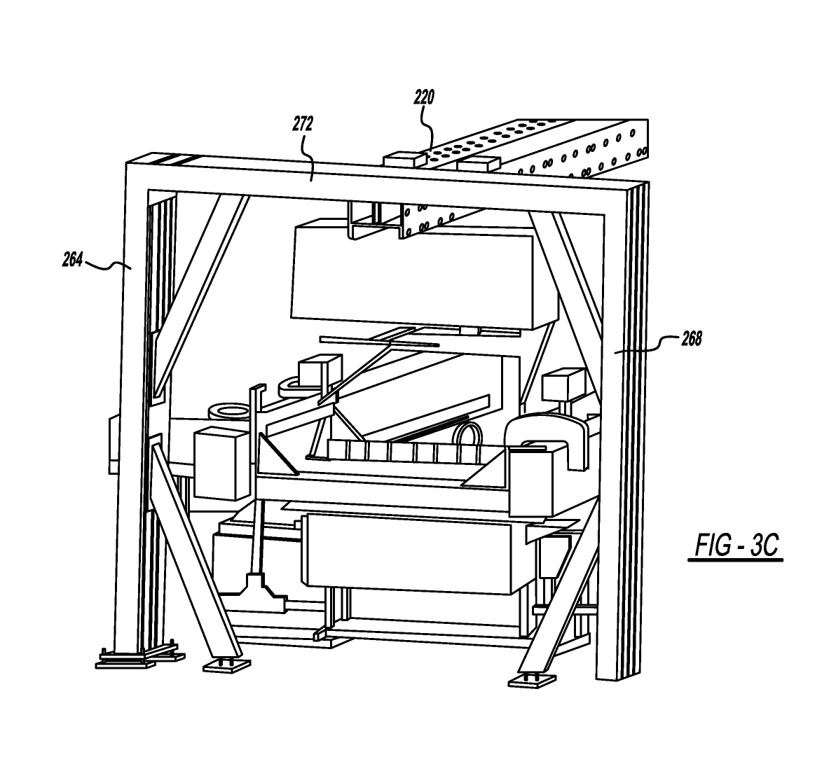

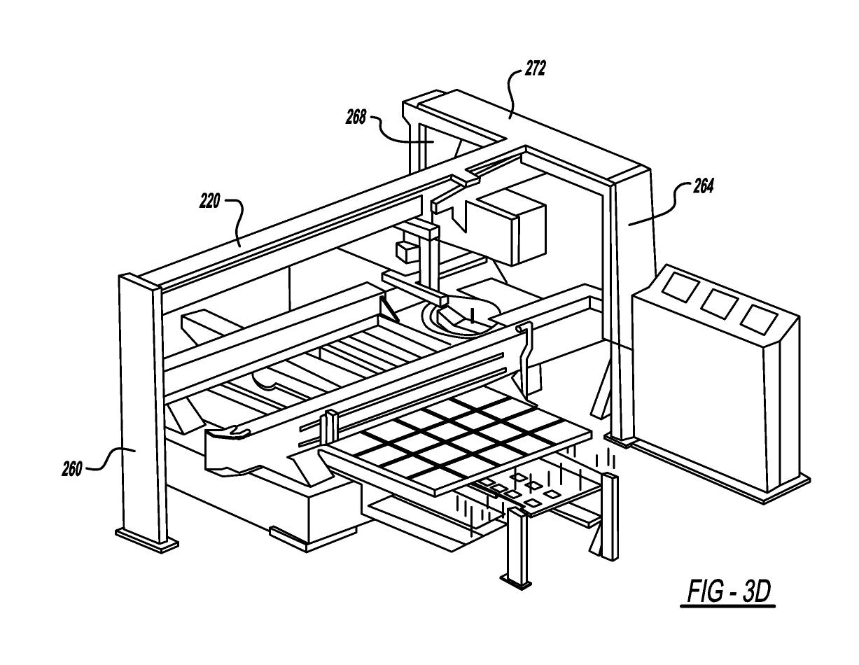

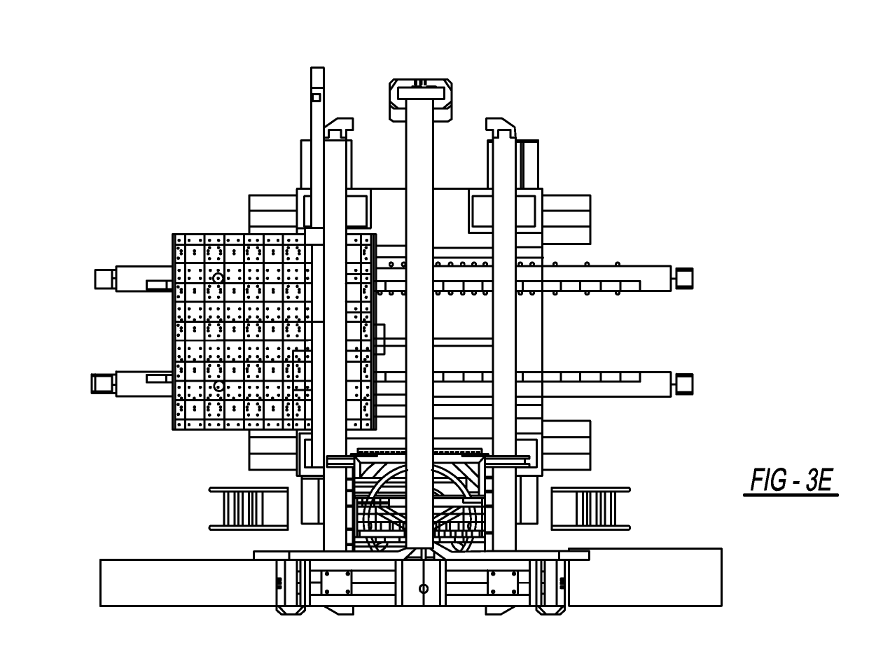

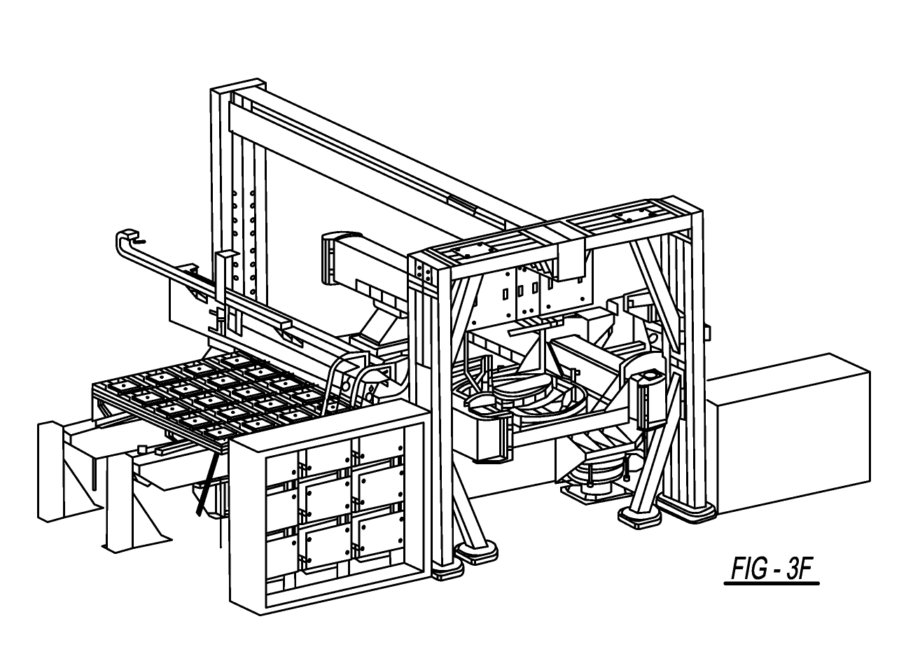

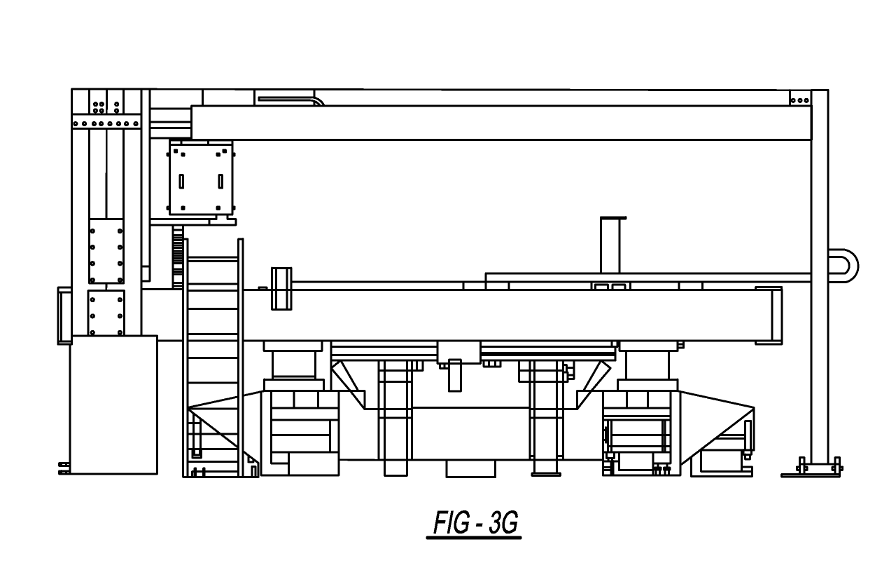

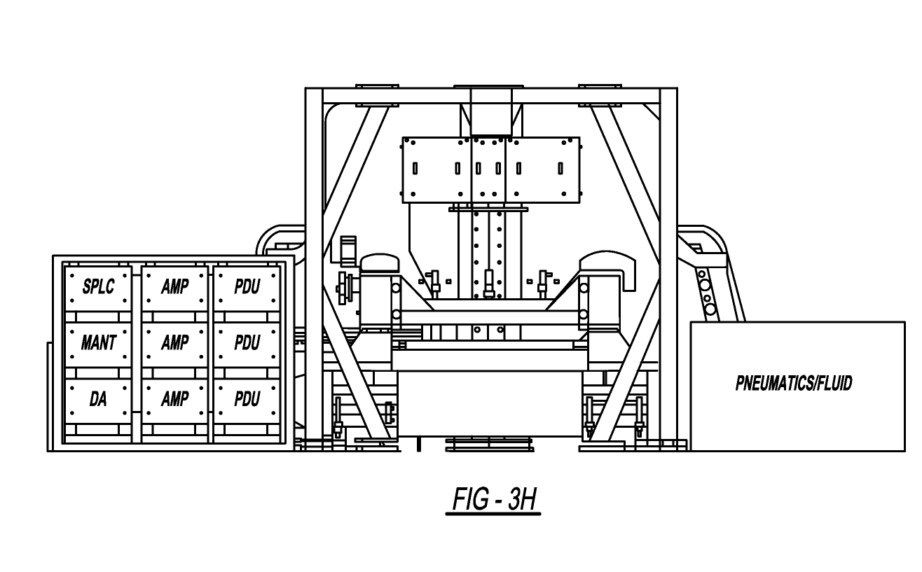

Referring now to FIG. 3A, an example implementation of the accessory superstructure 214 is shown. The accessory carriage 210 is shown rotated to be perpendicular to the upper beam 220. The accessory carriage 210 is attached via a rotating assembly to a linear motor that moves along the upper beam 220. An interlock bracket 250 is also attached to the linear motor. The interlock bracket 250 includes a hollow channel 254 in which electrical and/or vacuum lines are routed to the printhead carriage 104. The interlock bracket 250 is designed to allow clearance for the accessory carriage 210 to rotate to be parallel to the upper beam 220. The interlock bracket 250 may also be attached to mechanical interlocks that mechanically prevent misalignment between the printhead carriage 104 and the accessory carriage 210 from increasing beyond a threshold.

Referring now to FIG. 3B, an example implementation of the accessory superstructure 214 includes the upper beam 220, a first support leg 260, and second and third support legs 264 and 268. The upper beam 220 is connected to a support plate 272 that runs between the second and third support legs 264 and 268. The support legs 260, 264, and 268 create a triangular support structure that provides rigidity in both the x and y dimensions. The void between the second and third support legs 264 and 268 also allows for easy access to the printhead carriage 104 and other structures.

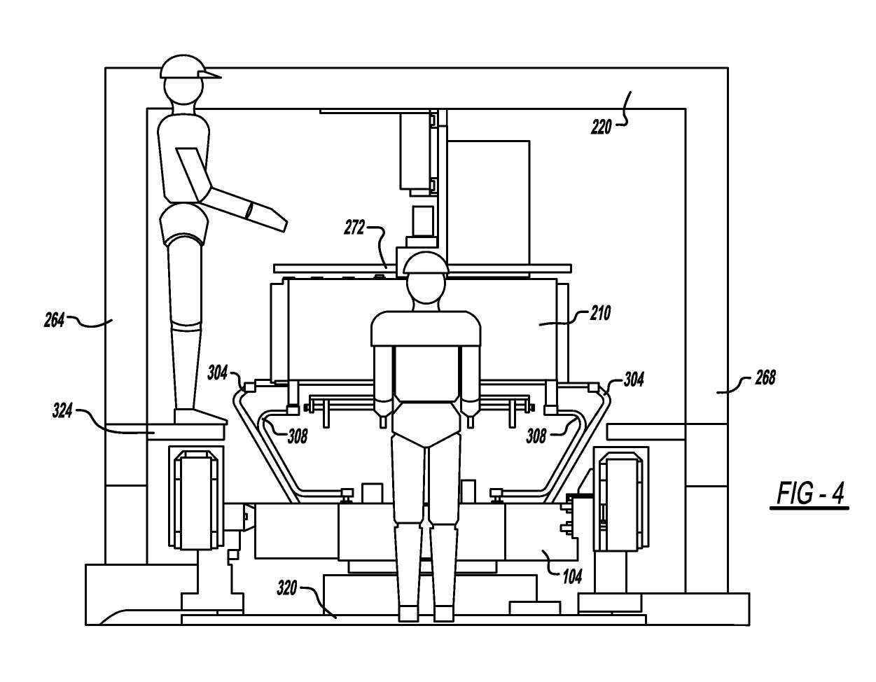

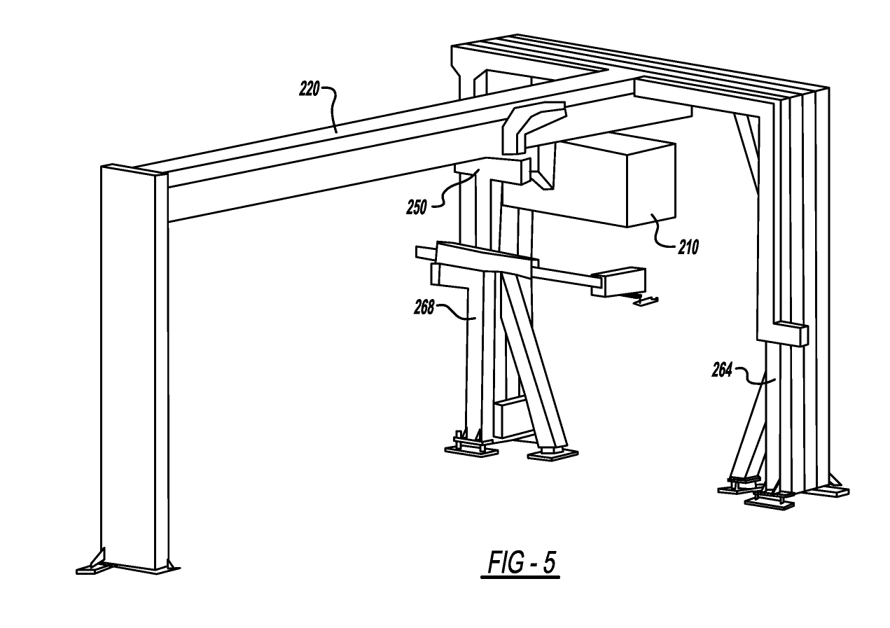

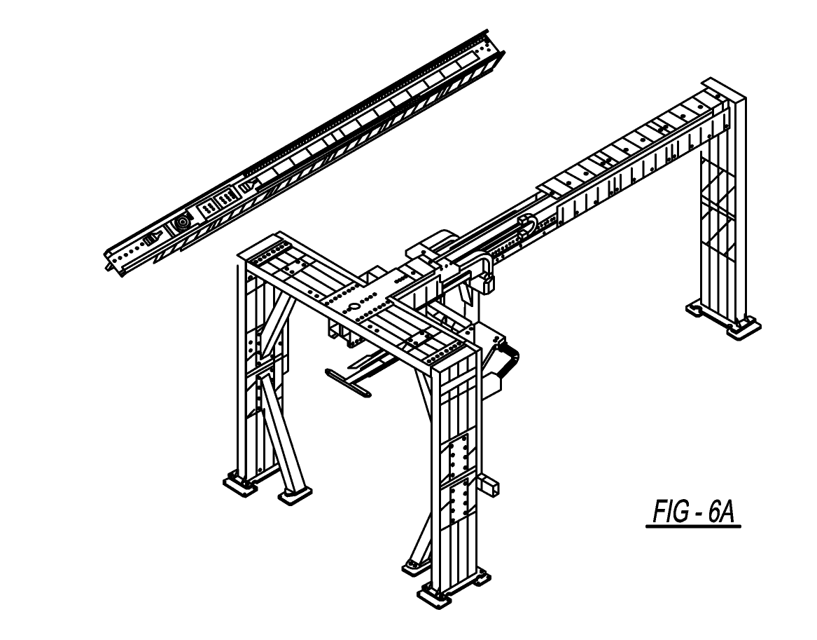

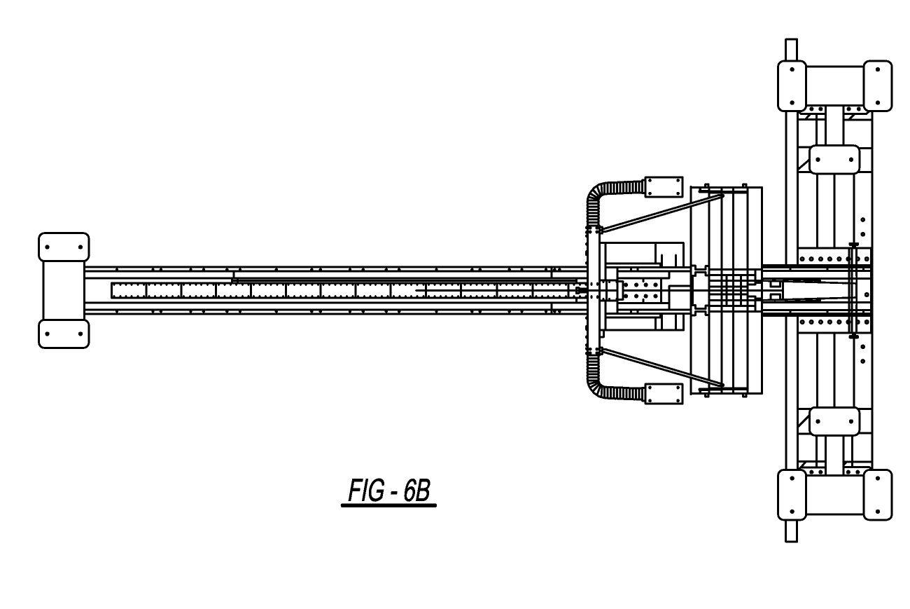

Referring now to FIG. 4, the accessory carriage 210 and the printhead carriage 104 are shown along with electrical interconnections 304 and fluid interconnections 308. A first service platform 320 may be located between the second and third support legs 264 and 268. A second service platform 324 may be attached to a second support beam 264. The second service platform 324 may be used to service the accessory carriage 210.

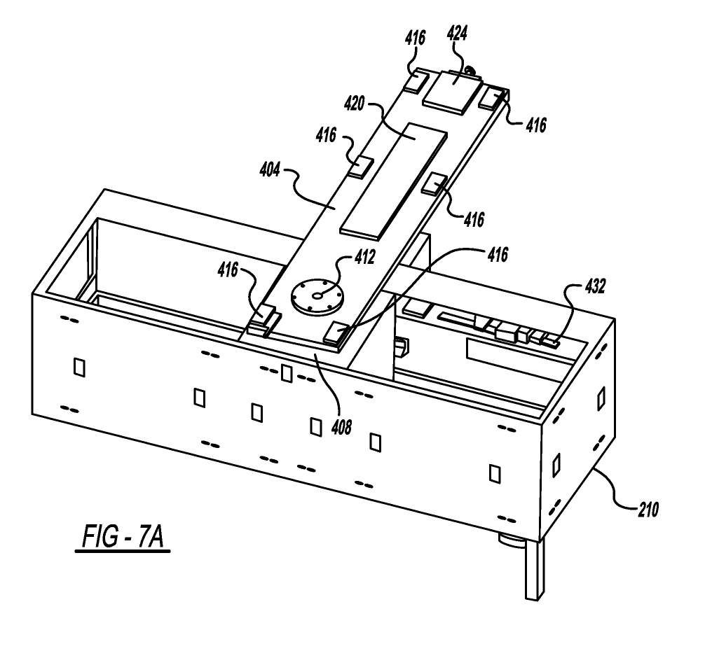

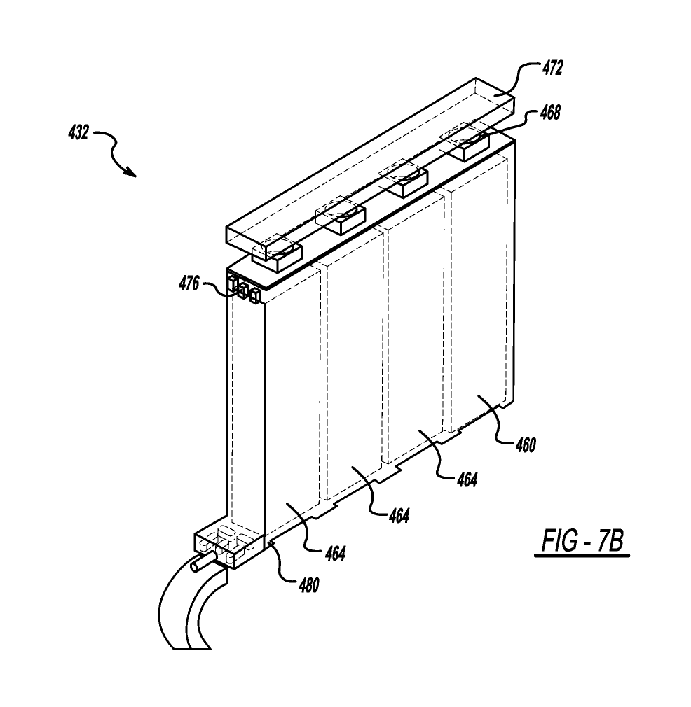

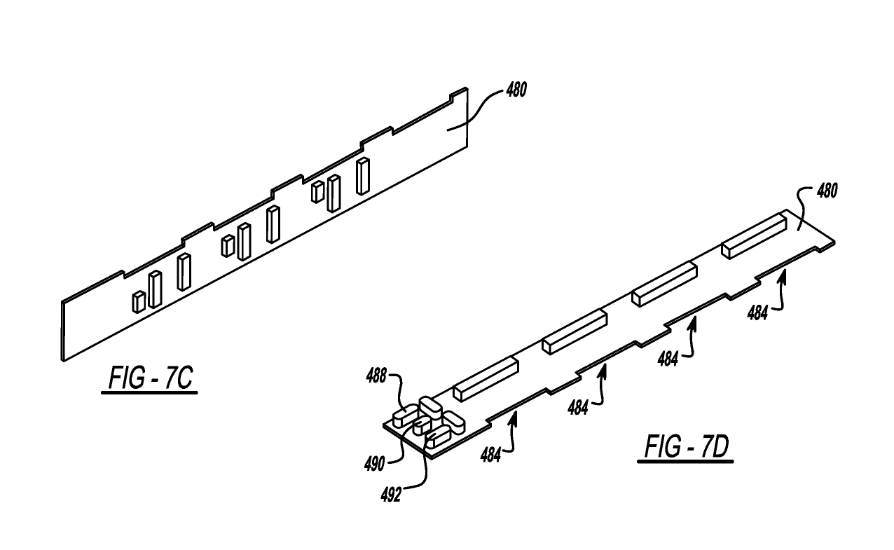

Referring now to FIG. 7A, a clamping plate 404 supports the accessory carriage 210. A motor 408 attaches to the clamping plate 404 via a rotary bearing 412. The motor 408 rotates the accessory carriage 210 with respect to the clamping plate 404. The motor 408 locks the accessory carriage 210 into a desired angle using servo control.

The clamping plate slides along the underside of the upper beam 220 of the accessory superstructure 214. Roller bearings 416 slide along linear mechanical bearing rails on the underside of the upper beam 220. A linear motor winding 420 propels the clamping plate 404 along the upper beam 220. The interlock bracket 250 attaches to the clamping plate 404 via a backing plate 424.

In various implementations, the bearings 416 may be sliding plastic pads. An example of the electronics pack 432 is shown inserted in the accessory carriage 210. In various implementations, the accessory carriage 210 may include 8 of the electronics packs 432. Each electronics pack 432 may control three printhead modules. Therefore, 8 of the electronic packs may control 24 printhead modules arranged in four packs of six printhead modules.

Referring now to FIG. 7B, an example implementation of the electronics pack 432 includes a power module 460 and three printhead control modules 464. In various implementations, the power module 460 may have the same physical dimensions as the printhead control modules 464. One or more fans 468 may draw air past the power module 460 and printhead control modules 464 to provide cooling. A filter 472 may remove particulate matter from the air, as microdeposition systems are often installed in clean rooms. The electronics pack 432 may be controlled via a networking port 476, such as an ethernet port. The power module 460 and the printhead control modules 464 may be mounted to a printed circuit board 480.

Referring now to FIGS. 7C-7D, views of the bottom and top of the printed circuit board 480, respectively, are shown. The printed circuit board 480 includes reliefs 484 to allow air through for cooling. In addition, the printed circuit board 480 may include a power connector 488, a control area network (CAN) bus connector 490, and a daisy chain encoder connector 492. The power module 460 may provide power to the printhead control modules 464 via the printed circuit board 480.

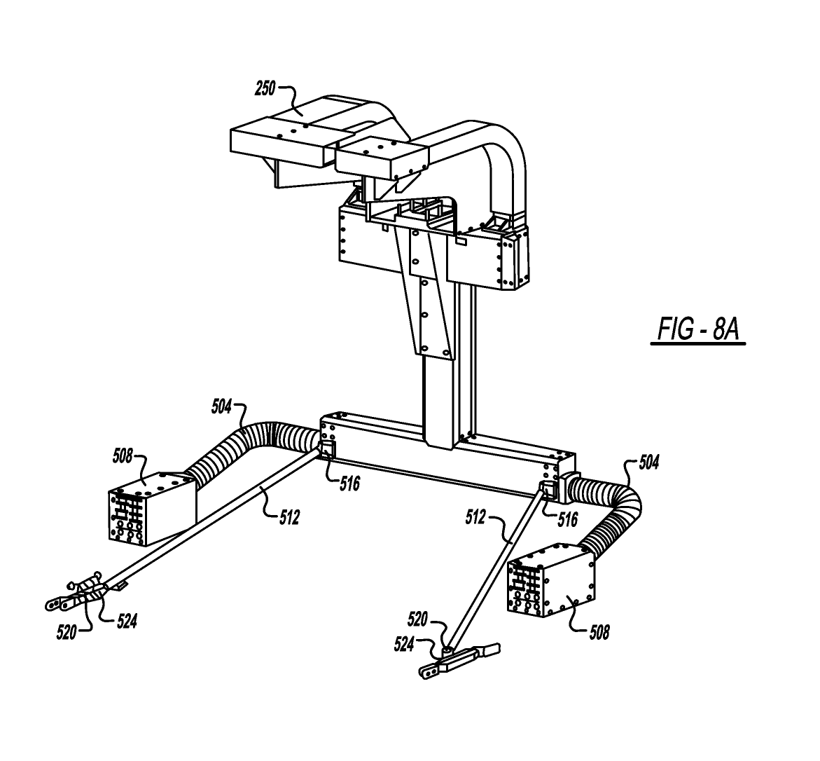

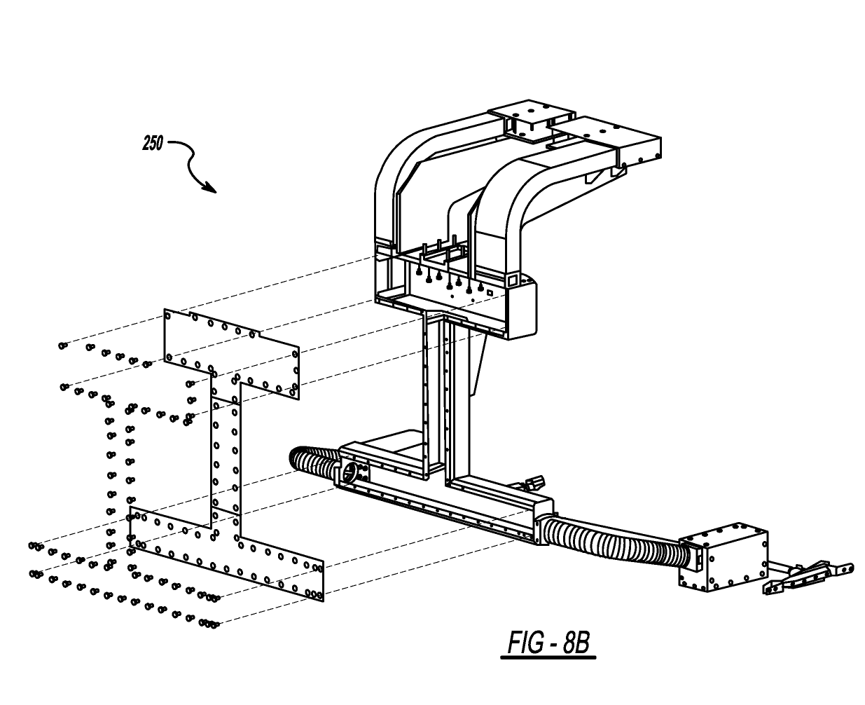

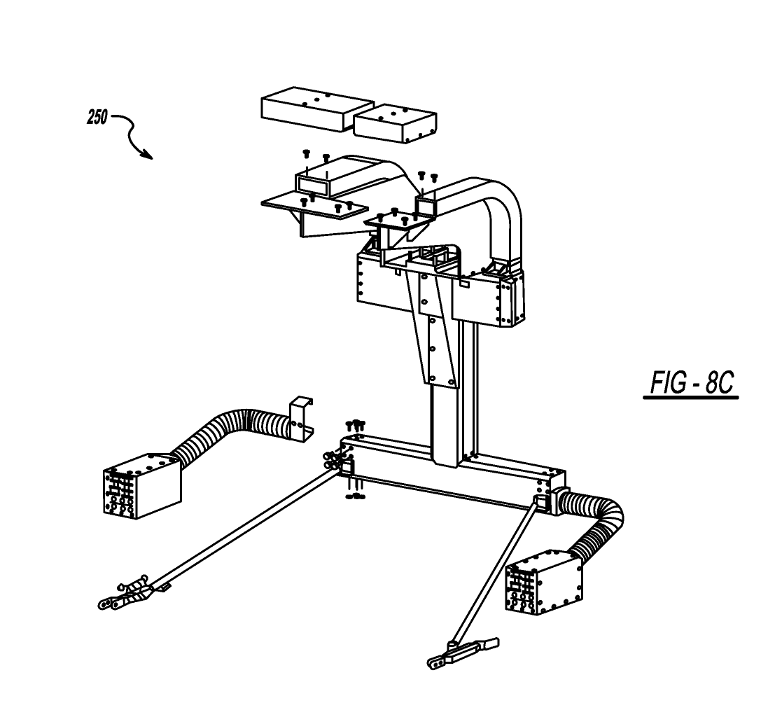

Referring now to FIG. 8A, the interlock bracket 250 includes flexible couplings 504 in which electrical lines run from the interlock bracket 250 to distribution boxes 508 that attach to the printhead carriage 104. The electrical lines run through the flexible couplings 504 may provide encoder signals and drive signals for the linear motors of the printhead carriage 104. The interlock bracket 250 may not rotate along with the accessory carriage 210 and the printhead carriage 104. The flexible couplings 504 may therefore not provide printhead signals because the printheads do rotate within the printhead carriage 104.

However, the linear motors that drive the printhead carriage 104 in the x axis do not rotate and can therefore be fed by the flexible couplings 504. In addition, power for the rotary turntable and for translation in the z axis may be provided through the flexible couplings 504. In addition, air lines may be run through the flexible couplings 504. Air lines may be used to lock the printhead carriage 104 in place. In various implementations, the flexible couplings 504 may be one-half inch in diameter.

Interlink rods 512 connect the interlock bracket 250 to the printhead carriage 104. The interlock rods 512 may connect to the interlock bracket 250 via spherical pivots 516. The interlock rods 512 may connect to sliding assemblies 520 on the printhead carriage 104 via spherical pivots 524. For example only, the sliding assemblies 520 may use linear ball bearings.

Misalignment between the accessory carriage 210 and the printhead carriage 104 can be detected by the position of the sliding assemblies 520. Mechanical stops may prevent the sliding assemblies 520 from moving further than a specified distance, such as plus or minus 25 millimeters. If they do, the mechanical stops mechanically lock the interlock bracket (and therefore the accessory carriage 210) to the printhead carriage 104. In addition, limit switches, such as optical switches, detect this condition, resulting in sending a halt signal to the linear motors of the accessory carriage 210 and the printhead carriage 104.

Referring now to FIG. 8B, a partial exploded view of the interlock bracket 250 reveals the hollow channel 254 in the body of the interlock bracket 250.

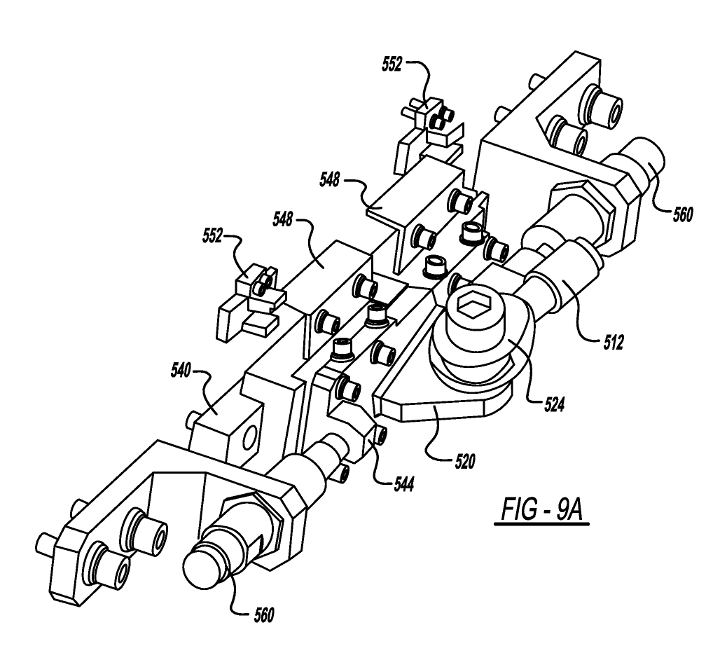

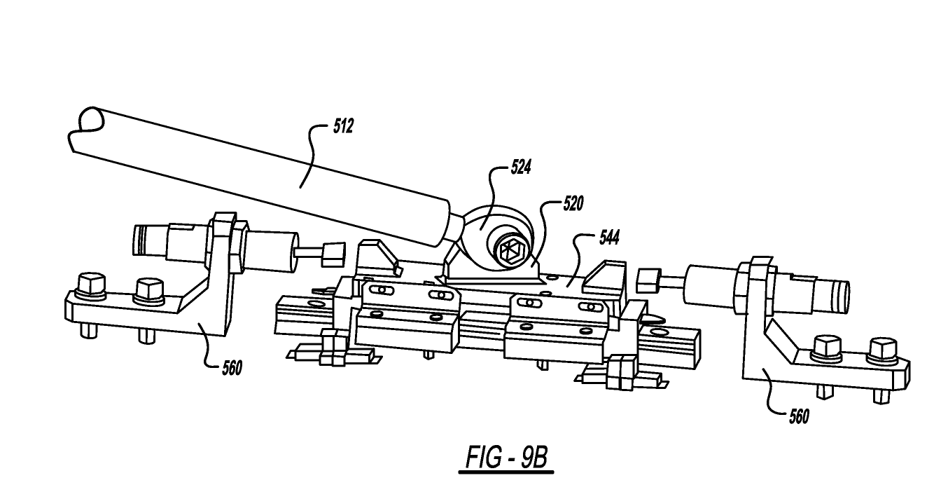

Referring now to FIGS. 9A and 9B, the interlock rod 512 attaches to the sliding assembly 520 via the spherical pivot 524. The sliding assembly 520 rides along a linear rail 540 on a recirculating ball bearing block 544. The linear rail 540 is rigidly mounted to the printhead carriage 104. The recirculating ball bearing block may be attached to limit switch flags 548. Limit switches 552 are attached to the printhead carriage 104 so that when the limit switch flags 548 cross the limit switches 552, excessive offset between the printhead carriage 104 and the accessory carriage 210 is detected.

When one of the limit switches 552 is tripped, system electronics may trigger hard wired relays that disable current drive systems and short the motor windings to become generators and provide braking force. In addition, the recirculating ball bearing block 544 will run into mechanical hard stops 560. The mechanical hard stops 560 lock the printhead carriage 104 to the accessory carriage 210 via the interlock rods 512. Therefore, the printhead carriage 104 and the accessory carriage 210 are mechanically locked together even if electronic control of the printhead carriage 104 and/or the accessory carriage 210 fails or is slow to respond.

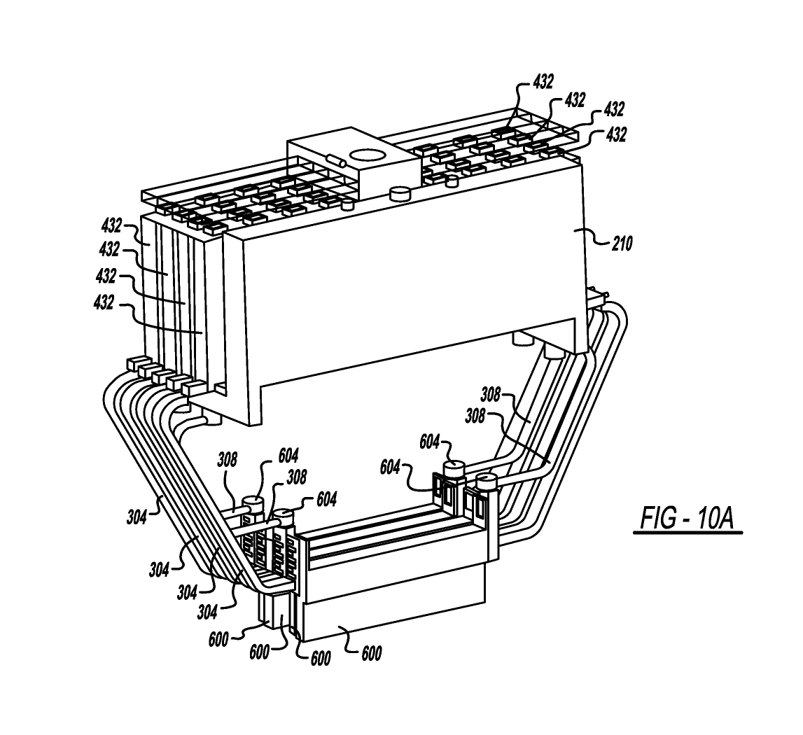

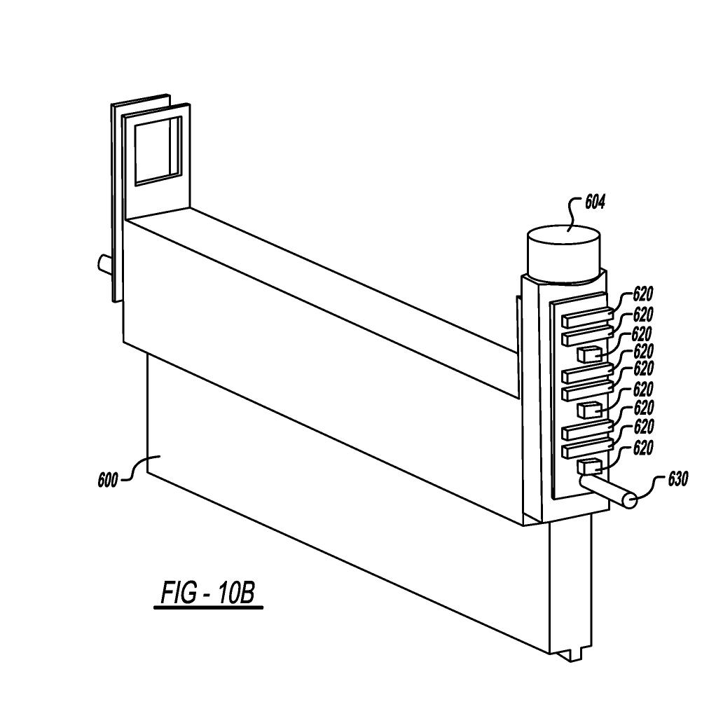

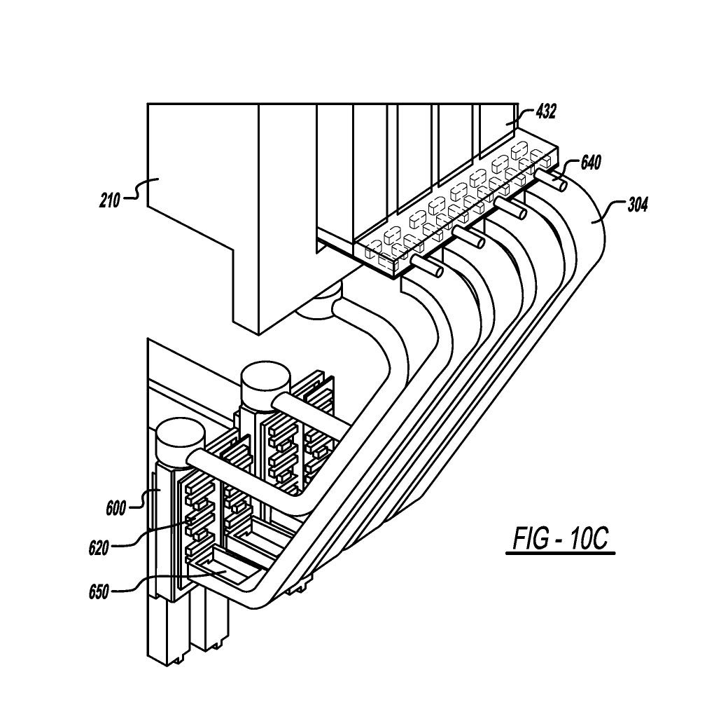

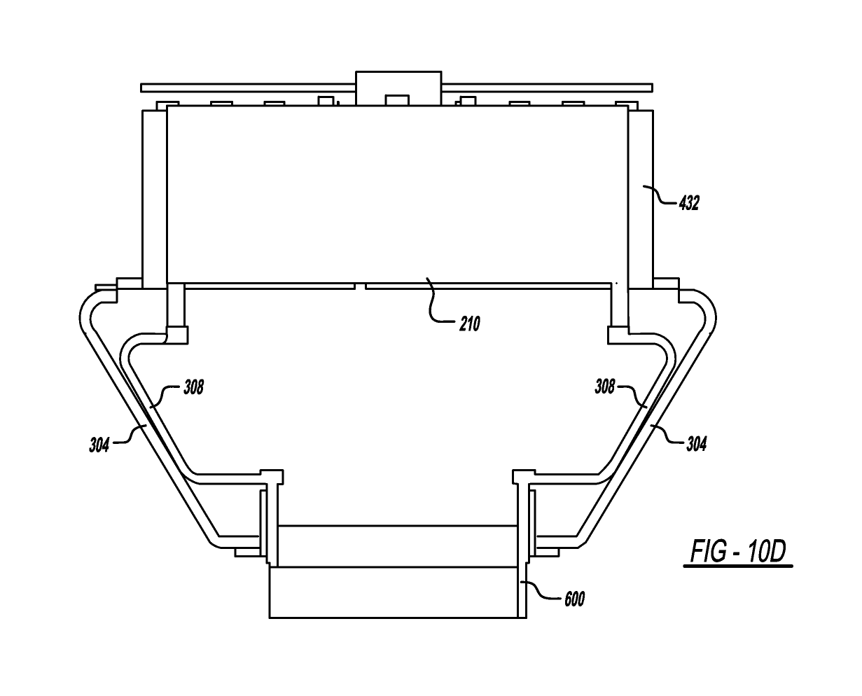

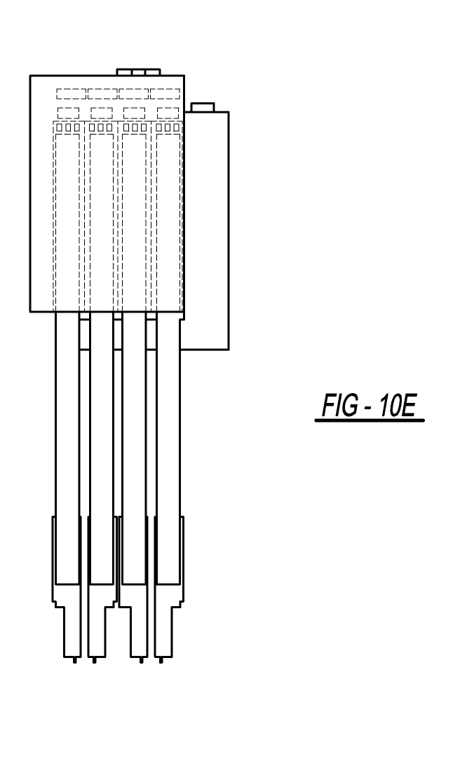

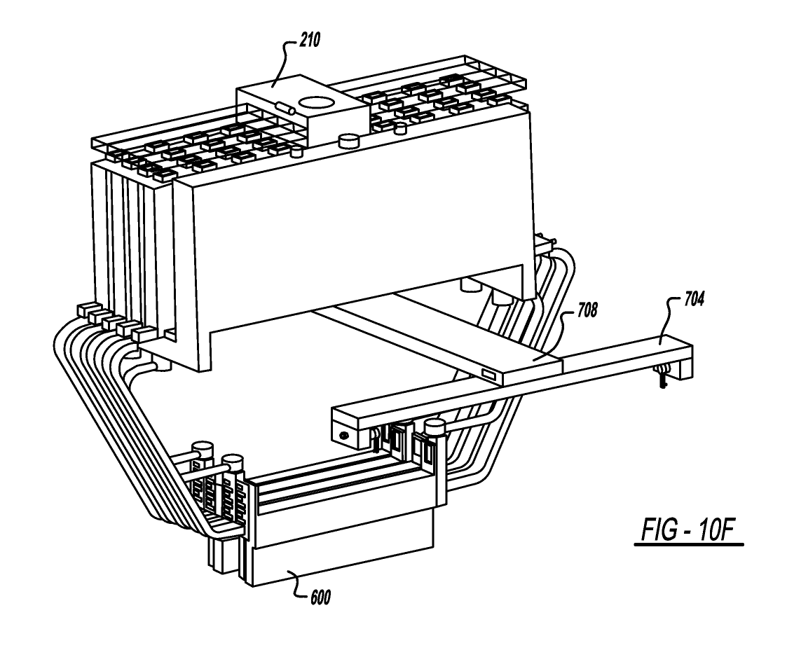

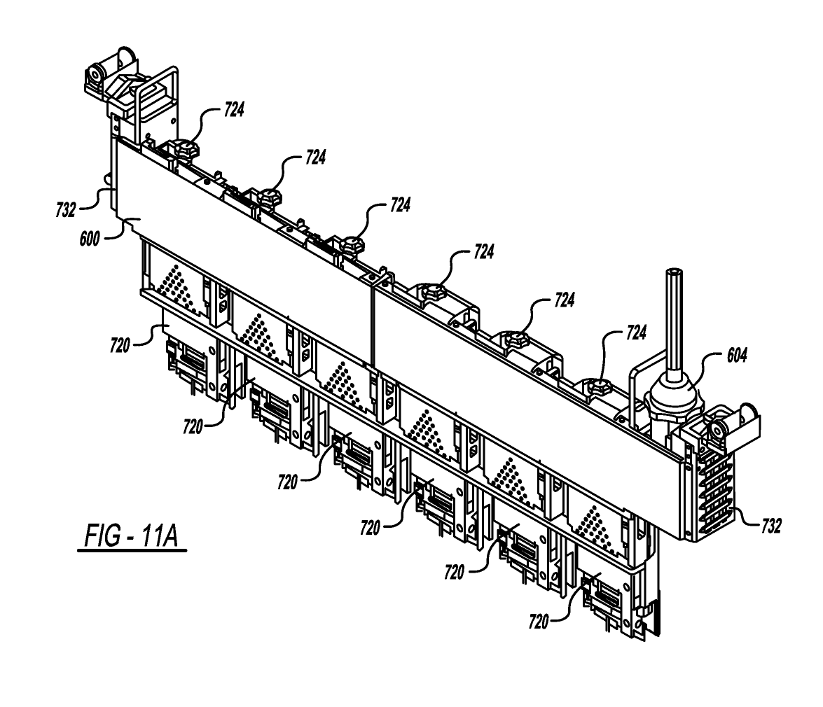

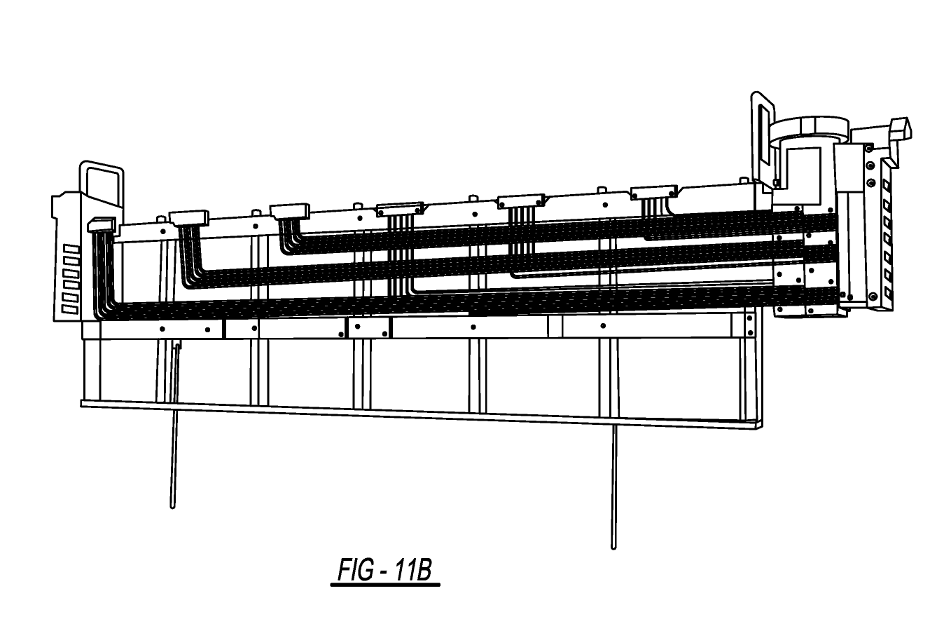

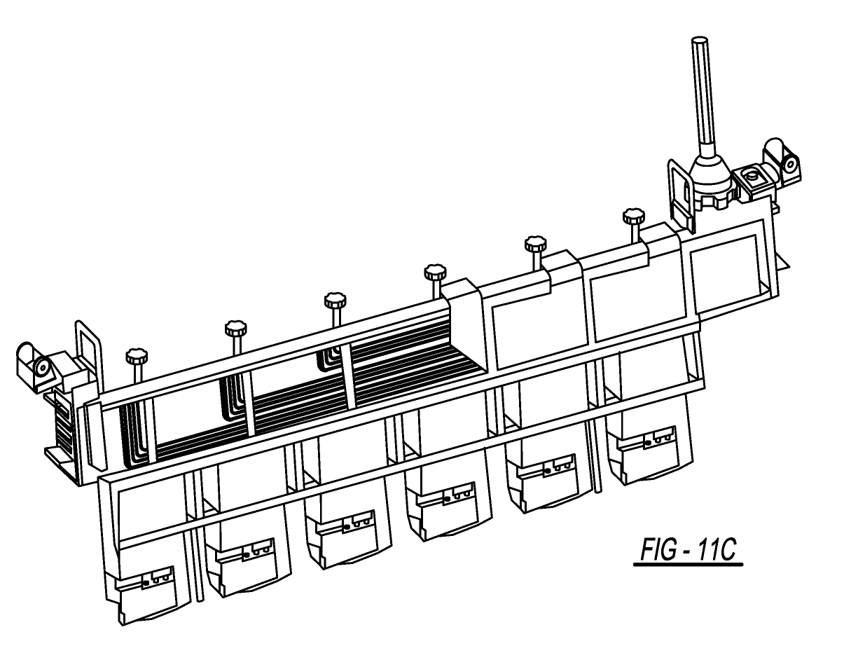

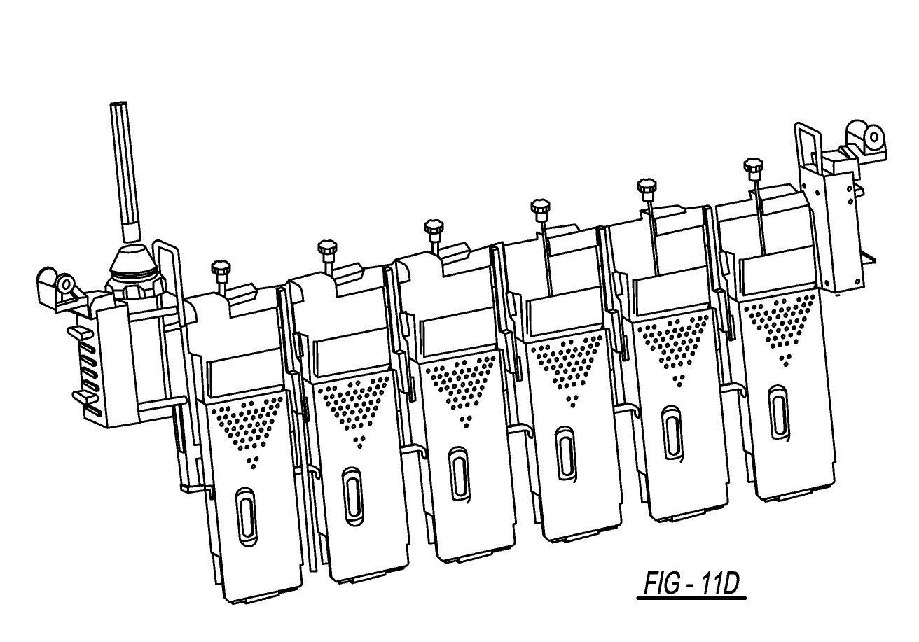

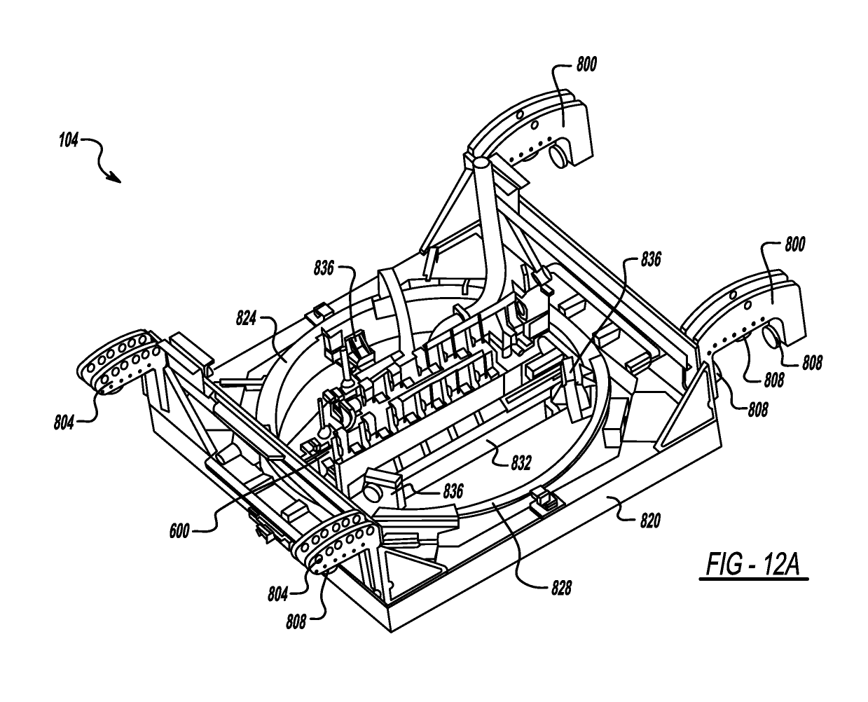

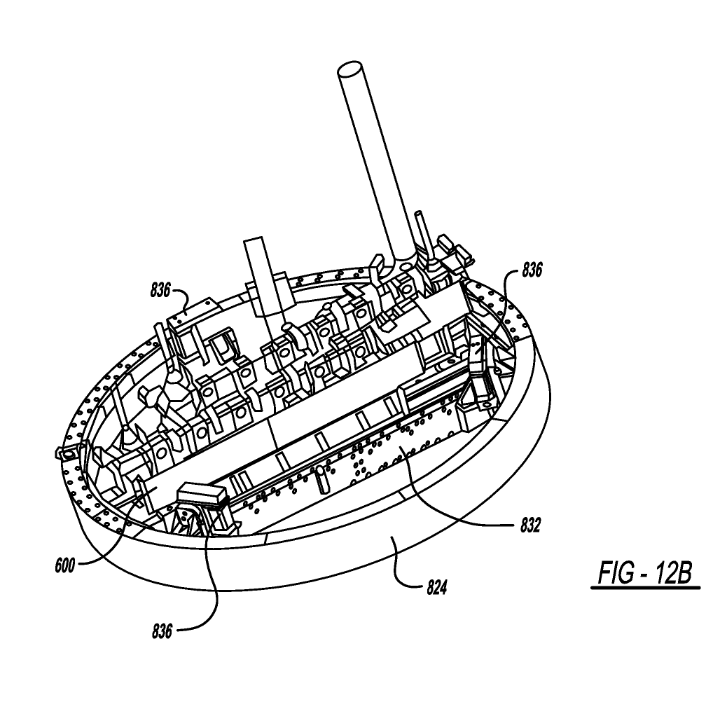

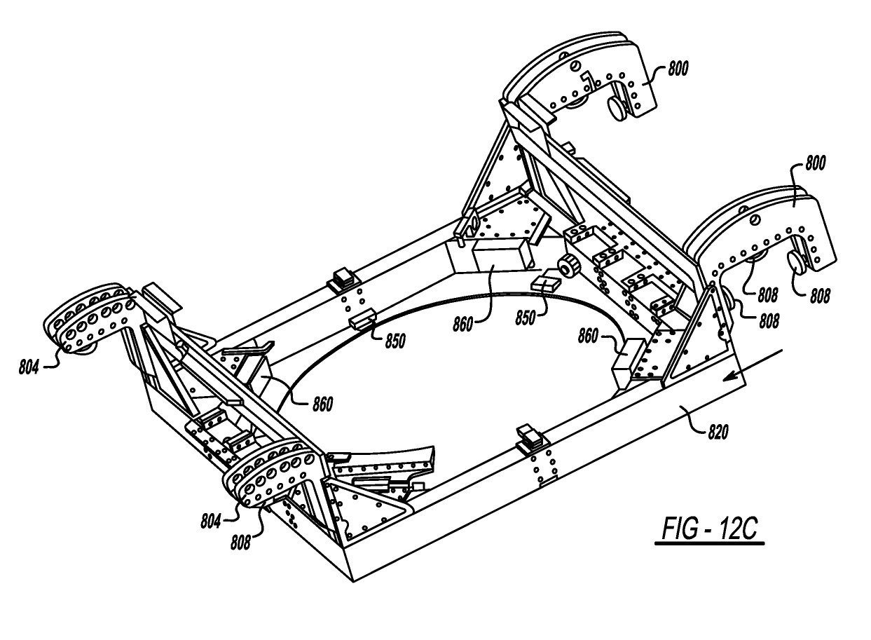

Referring now to FIG. 10A, the accessory carriage 210 may include eight of the electronics packs 432. Four packs 600 of printhead modules are shown. Each of the packs 600 includes a fluid port 604. Two of the packs 600 are arranged so that the fluid ports 604 are on one side of the printhead carriage 104, while the other two packs 600 are arranged so that the fluid ports 604 are on the other side. Each of the packs 600 includes an electrical connection 304 on each side of the pack 600. Each of the electrical connections 304 may include a flexible track that surrounds and supports one or more ribbon cables.

Referring now to FIG. 10B, an example implementation of the pack 600 is shown. The fluid port 604 is located on one end, while ribbon cable attachments 620 are located on both ends. The ribbon cable attachments 620 may correspond to those on the bottom of the printed circuit board 480, such as shown in FIG. 7C. A pin 630 may be a mounting point for the flexible track of the electrical connection 608. The pin 630 provides a point about which the track pivots.

Referring now to FIG. 10C, each of the electronics packs 432 may also include a pin 640, which allows the other end of the flexible track to pivot. The flexible track may include a series of interconnected links. For example only, the flexible track may include a plastic cable carrier system from IGUS, Inc. The flexible track includes an opening 650 from which the ribbon cables exit and attach to the ribbon cable connections 620 on the pack 600. Because the carrier is made of flexible links, the printhead carriage 104 can move with respect to the accessory carriage 210 in the x direction without the electrical connections 608 imposing any lateral forces on the printhead carriage 104.

Referring now to FIG. 10D, fluid lines 660 may rest against the electrical connections 608 to minimize movement of the fluid lines 660 and reduce strain on ports to which the fluid lines 60 connect.

Referring now to FIG. 10F, a service crane may include a gripping portion 704 and a sliding portion 708 that retains the gripping portion 704. The gripping portion 704 may lift one of the packs 600. The sliding portion 708 may slide out from the accessory carriage 210 to allow the packs 600 to be serviced or replaced. During normal operation, the sliding portion 708 may recess the gripping portion 704 underneath the accessory carriage 210.

Referring now to FIG. 11A, the pack 600 is shown with each of the printhead modules 720 pictured individually. Each printhead module 720 may be mechanically secured to the pack 600 via a threaded rod with a handle 724. Ribbon cable connectors 732 on one end of the packs 600 provide electrical signals to the three printhead modules 720 closest to the ribbon cable connectors 732. Meanwhile, ribbon cable connectors 732 on the other end provide electrical signals to the three printhead modules 720 closest to those ribbon cable connectors 732.

The fluid port 604 may be a multi-gang coupling that allows multiple fluid lines to be quickly connected and disconnected. The fluid port 604 provides and removes fluid for all of the printhead modules 720 of the pack 600. Example fluid routing for this is shown in FIG. 11B. A single fluid port 604 can be used for all of the printhead modules 720 if the flow rates used for printing are slow and the pressure drop differences are relatively insignificant in long runs of tubing.

Electrical signals are provided at each end of the packs 600 to improve signal integrity. For example only, wire lengths are kept below 2 meters to meet signal integrity requirements. Providing all ribbon cables at one end of the pack 600 may violate this requirement. In various implementations, one ribbon cable connector of each of the ribbon cable connectors 732 and 736 include a CAN bus connector. In various implementations, two ribbon cables may be used for each of the printhead modules 720.

Referring now to FIG. 12A, an example implementation of the printhead carriage 104 is shown. Two support members 800 ride along one of the beams 108 of FIG. 1, while another two support members 804 ride along the other of the beams 108. Air bearing pucks 808 minimize friction between the printhead carriage 104 and the beams 108. The support members 800 wrap around one of the beams 108 to provide stability in the y direction as well as in the theta z direction. In other words, the support members 800 prevent the printhead carriage 104 from moving perpendicular to the beams 108 or from rotating in a plane parallel to the substrate.

The printhead carriage 104 includes a plinth 820, which supports a circular turntable 824. The turntable 824 may be rotated within the plinth 820 using a curvilinear motor 828. In various implementations, the turntable 824 may be non-rotating. A support structure 832 retains the packs 600. Multiple z actuators 836 may move the support structure 832 along the z axis with respect to the turntable 824. In various implementations, three z actuators 836 are used and are spaced apart from each other by 120 degrees.

Referring now to FIG. 12C, the plinth 820 includes bearings 850 that support the turntable 824, as well as bearings 860 that constrain the turntable 824 to only rotate and to not translate in the x-y plane. In various implementations, the turntable 824 may be an aluminum ring 1.5 meters in diameter and approximately 8 inches tall and 2 inches thick.

The broad teachings of the disclosure can be implemented in a variety of forms. Therefore, while this disclosure includes particular examples, the true scope of the disclosure should not be so limited since other modifications will become apparent to the skilled practitioner upon a study of the drawings, the specification, and the following claims.

What is claimed is:

1. A microdeposition system comprising:
a printhead carriage that moves along a first axis;
a stage that holds a substrate beneath the printhead carriage and that moves the substrate along a second axis perpendicular to the first axis, wherein the printhead carriage includes a plurality of nozzles that deposit droplets of fluid material onto the substrate;
a rail located above the printhead carriage and extending along a third axis parallel to the first axis;
a mounting bracket that moves along the rail;
an accessory carriage that is rotatably attached to the mounting bracket and that includes firing electronics that control firing of the plurality of nozzles; and
a position controller that controls the accessory carriage and the printhead carriage to move in unison, wherein:
the printhead carriage includes a plinth and a turntable,
the turntable holds printheads including the plurality of nozzles and rotates within the plinth,
the accessory carriage rotates in unison with the turntable,
the printhead carriage includes motors that move the printhead carriage along the first axis,
the position controller electrically communicates with the motors via cables routed along the mounting bracket,
the position controller controls a position of the printhead carriage along the first axis to a first accuracy and controls a position of the accessory carriage along the third axis to a second accuracy that is less accurate than the first accuracy,
vacuum, solvent, pressurized air, and the fluid material are transmitted between the accessory carriage and the turntable using flexible fluid connections,
firing signals from the firing electronics are transmitted between the accessory carriage and the turntable using flexible electrical connections,
the plinth includes sliding couplings that slide parallel to the first axis,
the accessory carriage is interlocked with the sliding couplings by rigid interlink rods,
the interlink rods have first ends pivotably coupled to the accessory carriage,
the interlink rods have opposite ends pivotably coupled to the sliding couplings,
the plinth includes sensors that generate error signals when the sliding couplings move past first predetermined positions on the plinth,
the position controller stops movement of the accessory carriage and the printhead carriage when one of the error signals is generated, and
the plinth includes hard stops that prevent the sliding couplings from moving past second predetermined positions on the plinth.

2. A microdeposition system comprising:
a printhead carriage that moves along a first axis;
a stage that holds a substrate, wherein the printhead carriage includes a plurality of nozzles that deposit droplets of fluid material onto the substrate;
a rail located above the printhead carriage and extending along a second axis parallel to the first axis; and
an accessory carriage that travels along the rail to remain above the printhead carriage.

3. The microdeposition system of claim 2 wherein the accessory carriage includes firing electronics that control firing of the plurality of nozzles.

4. The microdeposition system of claim 3 wherein firing signals from the firing electronics are transmitted between the accessory carriage and the printhead carriage using flexible electrical connections.

5. The microdeposition system of claim 2 further comprising a position controller that controls the accessory carriage and the printhead carriage to move in unison.

6. The microdeposition system of claim 5 wherein the position controller controls a position of the printhead carriage along the first axis to a first accuracy and controls a position of the accessory carriage along the second axis to a second accuracy, wherein the second accuracy is less accurate than the first accuracy.

7. The microdeposition system of claim 6 wherein the first accuracy is at least 1000 times as accurate as the second accuracy.

8. The microdeposition system of claim 5 further comprising an interlock bracket that slides along the rail, wherein the accessory carriage is mounted to the interlock bracket, wherein the printhead carriage includes a motor that moves the printhead carriage along the first axis, and wherein the position controller electrically communicates with the motor via cables routed along the interlock bracket.

9. The microdeposition system of claim 8 further comprising an air line routed along the interlock bracket that actuates a device to lock the printhead carriage in place.

10. The microdeposition system of claim 2 further comprising an interlock bracket that slides along the rail, wherein the accessory carriage is mounted to the interlock bracket, wherein the printhead carriage includes a plinth and a turntable, and wherein the turntable holds printheads including the plurality of nozzles.

11. The microdeposition system of claim 10 wherein the plinth includes motors that move the turntable along an axis perpendicular to the substrate, and wherein control signals for the motors are transmitted from the accessory carriage via cables routed along the interlock bracket.

12. The microdeposition system of claim 10 wherein the turntable rotates within the plinth in a plane parallel to the substrate, and wherein the accessory carriage is rotatably attached to the interlock bracket.

13. The microdeposition system of claim 12 wherein the accessory carriage rotates in unison with the turntable.

14. The microdeposition system of claim 12 wherein control signals for rotation of the turntable are transmitted via cables routed along the interlock bracket.

15. The microdeposition system of claim 2 wherein vacuum, solvent, pressurized air, and the fluid material are transmitted between the accessory carriage and the printhead carriage using flexible fluid connections.

16. The microdeposition system of claim 2 wherein the printhead carriage includes a sliding coupling that slides along a direction parallel to the first axis, and further comprising a rigid interlink rod connected between the accessory carriage and the sliding coupling.

17. The microdeposition system of claim 16 wherein the printhead carriage includes at least two sliding couplings, and further comprising at least two rigid interlink rods that connect the accessory carriage to respective ones of the sliding couplings.

18. The microdeposition system of claim 16 wherein the printhead carriage includes a sensor that generates an error signal when the sliding coupling moves past first predetermined positions on the printhead carriage, and wherein movement of the accessory carriage and the printhead carriage is stopped when the error signal is generated.

19. The microdeposition system of claim 18 wherein the printhead carriage includes hard stops that prevent the sliding coupling from moving past second predetermined positions on the printhead carriage.

20. The microdeposition system of claim 2 further comprising at least one beam that is parallel to the first axis and is mechanically isolated from the rail, wherein the printhead carriage moves along the at least one beam.
